(19) United States
(12) Patent Application Publication
(10) Pub. No.: US 2011/0064417 A1
(43) Pub. Date: Mar. 17, 2011

(54) COMMUNICATION SYSTEM

(75) Inventor: Tetsuji Sato, Kawasaki (JP)

(73) Assignee: FUJITSU OPTICAL COMPONENTS LIMITED, Kawasaaki-shi (JP)

(21) Appl. No.: 12/879,920

(22) Filed: Sep. 10, 2010

(30) Foreign Application Priority Data
Sep. 11, 2009 (JP) 2009-210193

(51) Int. Cl. H04B 10/00

(52) U.S. Cl. 398/135

(57) ABSTRACT

In a communication system, a signal processor of a communication apparatus transmits, when causing a communication module to perform a predetermined operation, a control signal at a predetermined level. Further, when authenticating the communication module, the signal processor changes a level of the control signal into a previously set authentication pattern and transmits the control signal. An operation controller of the communication module receives the control signal transmitted from the signal processor. When a level of the received control signal is a predetermined level, the operation controller performs a predetermined operation corresponding to the predetermined level. Further, when a level of the received control signal is an authentication pattern, the operation controller performs authentication control by matching or comparing the authentication pattern with a previously recognized pattern.

### CROSS-REFERENCE TO RELATED APPLICATION(S)

This application is based upon and claims the benefit of priority of the prior Japanese Patent Application No. 2009-210193, filed on Sep. 11, 2009, the entire contents of which are incorporated herein by reference.

### FIELD

The embodiment discussed herein is related to a communication system that performs information communication.

### BACKGROUND

An optical transceiver has a photoelectric conversion function and is an optical module that realizes high-speed optical data communication, thus drawing attention as a key component of an optical communication system. In the optical transceiver, specifications of outlines and electrical interfaces are set based on the International Standard Specifications called an MSA (Multi Source Agreement). In particular, a standard of an XFP (10 Gbps Small Form-factor Pluggable) compliant with the MSA becomes mainstream in an optical communication of 10 Gbps.

The optical transceiver has a pluggable configuration in which removal and exchange operations are facilitated, and is capable of replacing optical transceivers of the user side with respect to an apparatus of the host side. This process permits a function enhancement and a specification change to be easily performed.

As a conventional technique, a technique in which unauthorized optical data links are excluded is provided (see, for example, Japanese Laid-open Patent Publication No. 2006-325030). A technique in which a two-way dialogue is performed between apparatuses and an authentication is performed is provided (see, for example, Published Japanese Translation of a PCT application No. 2005-534089).

As can be seen from the above discussion, the optical transceiver has a significant advantage that an exchange can be easily performed. However, when an exchange can be performed on the user side, a user can use modules (for example, inexpensive modules except an optical transceiver authorized on the vendor side of a host apparatus) except an optical transceiver to be originally inserted into a host apparatus, and incorrectly perform communication. Therefore, there is the possibility that characteristics and quality of communication fail to be maintained, and the reliability threatens to be reduced.

On the other hand, optical transceivers represented by an XFP type exchange information with the host apparatus using general-purpose I²C communication (Inter-Integrated Circuit: a serial communication system with a peripheral device by a protocol for realizing high-speed communication mainly with a memory IC).

The optical transceiver is conventionally authenticated using the I²C communication between the host apparatus and the optical transceiver such that a normal communication is not performed between the host apparatus and the above-described unauthorized optical transceiver.

However, the I²C communication protocol is disclosed, and therefore, there is the possibility that an I²C signal is illegally monitored and authentication data is detected and reproduced. As a result, the conventional authentication method does not definitely prevent the use of the unauthorized optical transceiver.

### SUMMARY

According to one aspect of the present invention, there is provided a communication system to perform information communication. This communication system includes: a communication module including an operation controller that controls an operation of itself based on a control signal having no general-purpose communication protocol; and a communication apparatus including a signal processor that generates the control signal and transmits the generated control signal to the communication module inserted into itself, wherein: the signal processor: transmits, when causing the communication module to perform a predetermined operation, the control signal at a predetermined level, and changes, when authenticating the communication module, a level of the control signal into an authentication pattern and transmits the control signal; and the operation controller: performs, when a level of the received control signal is the predetermined level, the predetermined operation, and performs, when a level of the received control signal is the authentication pattern, authentication control by matching or comparing the authentication pattern with a previously recognized pattern.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING(S)

FIG. 1 illustrates a configuration example of a communication system;

FIG. 2 illustrates a configuration example of an optical transceiver;

FIG. 3 illustrates a configuration at the time when a plurality of optical transceivers are inserted into a communication apparatus;

FIG. 4 illustrates an authentication pattern at the time of authenticating the optical transceiver;

FIG. 5 illustrates the authentication pattern at the time of authenticating the optical transceiver;

FIG. 6 illustrates a monitor pattern at the time of performing monitor control of the optical transceiver; and

FIG. 7 illustrates one example of the monitor pattern.

### DESCRIPTION OF EMBODIMENT(S)

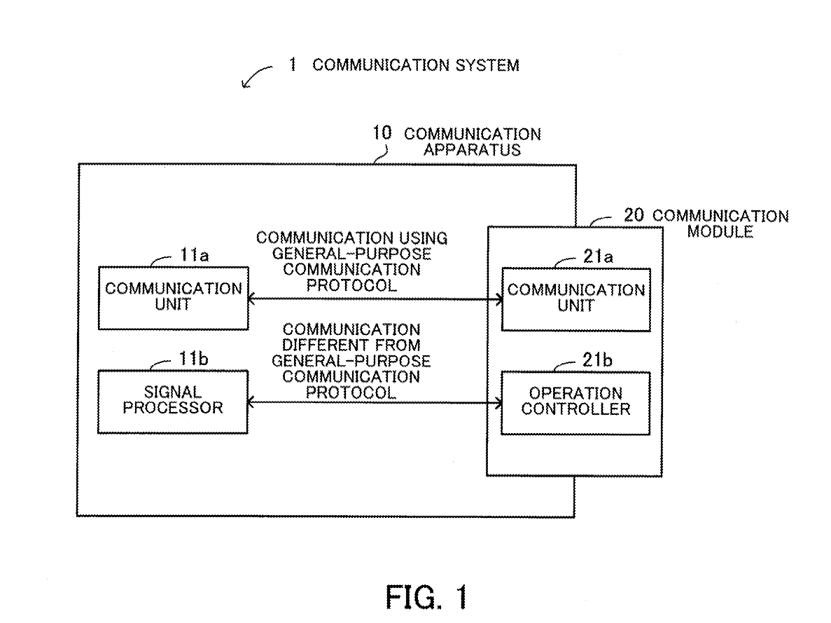

Preferred embodiments of the present invention will now be described in detail below with reference to the accompanying drawings, wherein like reference numerals refer to like elements throughout. FIG. 1 illustrates a configuration example of a communication system. The illustrated communication system 1 includes a communication apparatus 10 and a communication module 20, and is a system that inserts the communication module 20 into the communication apparatus 10 and performs information communication between the communication apparatus 10 and the communication module 20.

The communication apparatus 10 includes a communication unit 11a and a signal processor 11b. The communication unit 11a communicates with the communication module 20 using a general-purpose communication protocol (for example, I²C communication protocol). The signal processor 11b generates a control signal and transmits the generated control signal to the communication module 20 inserted into itself.

The communication module 20 includes a communication unit 21a and an operation controller 21b. The communication unit 21a communicates with the communication apparatus 10 using the general-purpose communication protocol. The operation controller 21b controls an operation of itself based on a control signal having no general-purpose communication protocol.

The control signal having no general-purpose communication protocol means, for example, a control signal that does not depend, when the general-purpose communication protocol is an I²C communication protocol, on a communication format using the I²C communication protocol.

Here, when causing the communication module 20 to perform a predetermined operation, the signal processor 11b sets a level of a control signal to a predetermined constant level and transmits the control signal to the communication module 20 (to transmit a signal having an H level or an L level for a given length of time). When authenticating the communication module 20, the signal processor 11b changes a level of the control signal into a previously set authentication pattern and transmits the control signal. Further, when monitoring various functions of the communication module 20, the signal processor 11b changes a level of the control signal into a previously set monitor pattern and transmits the control signal.

On the other hand, the operation controller 21b receives the control signal transmitted from the signal processor 11b and, when a level of the received control signal is a predetermined level, performs a predetermined operation corresponding to the level.

When a level of the received control signal is a level change pattern of the authentication pattern, the operation controller 21b performs an authentication control by matching or comparing the level change pattern with a previously recognized pattern. Further, when a level of the received control signal is a level change pattern of the monitor pattern, the operation controller 21b performs a monitor control in order to perform a function monitor of itself corresponding to each pattern of the monitor pattern and inform the communication apparatus 10 of the monitor results.

Next, as an example of the communication system 1, suppose that the communication module 20 is an XFP type pluggable optical transceiver module. A configuration and operations at the time when the optical transceiver is inserted into the communication apparatus 10 and then the communication is performed will be described in detail.

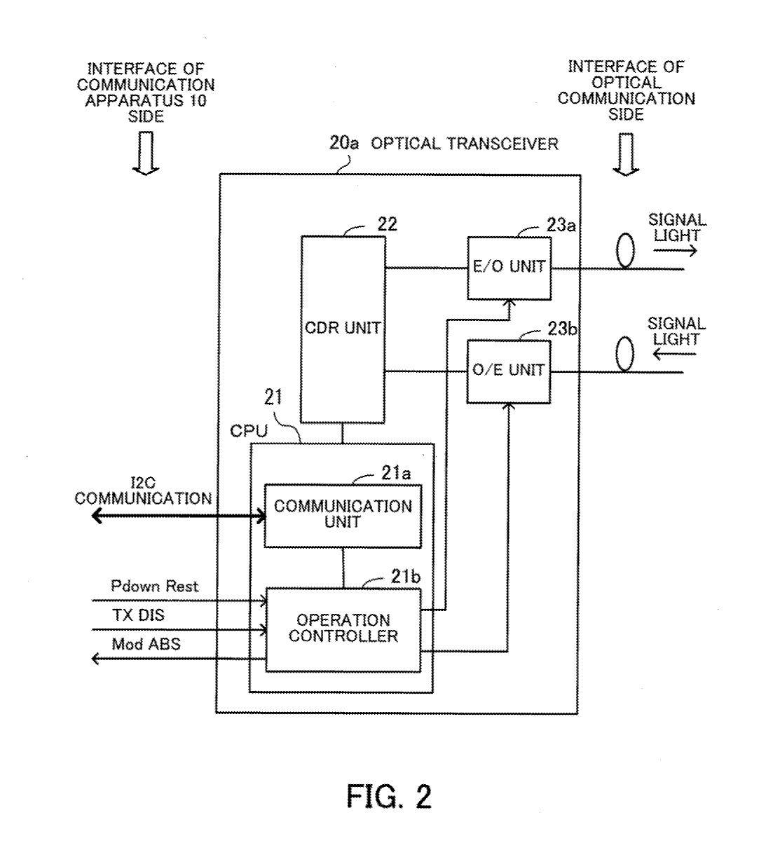

FIG. 2 illustrates a configuration example of an optical transceiver. The illustrated optical transceiver 20a includes a CPU (Central Processing Unit) 21, a CDR (Clock Data Recovery) unit 22, an E/O unit 23a, and an O/E unit 23b. The CPU 21 includes a communication unit 21a and an operation controller 21b. The CPU 21 performs operation control of the entire module except the communication unit 21a and the operation controller 21b.

The communication unit 21a communicates with the communication apparatus 10 using the I²C communication protocol. The operation controller 21b performs the operation control of itself based on a Pdown Rest (Power down Reset) signal, a TX DIS (TX Disable) signal, and a Mod ABS (Module Absence) signal as a control signal having no I²C communication protocol.

Here, the Pdown Rest signal sets and releases the optical transceiver 20a to and from the standby state as a predetermined operation of the optical transceiver 20a. The Pdown Rest signal is transmitted from the signal processor 11b of the communication apparatus 10 to the optical transceiver 20a, and reaches a Pdown Rest pin of the optical transceiver 20a.

For example, when the Pdown Rest signal having the H level of 10 μs or more reaches the Pdown Rest pin of the optical transceiver 20a, the operation controller 21b reduces power consumption of the optical transceiver 20a up to a constant level using the Pdown Rest signal, thus setting the optical transceiver 20a to a standby state (power down mode) for stopping an operation of the I²C communication or optical communication.

On the other hand, when Pdown Rest signal reaches the Pdown Reset pin at the L level, the operation controller 21b releases the optical transceiver 20a from a standby state using the Pdown Rest signal, thus performing a normal operation of the optical transceiver 20a (the operation controller 21b releases the optical transceiver 20a from the standby state and moves the optical transceiver 20a to a normal operation mode by a falling edge from the H level to the L level of the Pdown Rest signal).

A TX DIS signal causes the optical transceiver 20a to perform output and stop of signal light (corresponding to communication data) as a predetermined operation of the optical transceiver 20a. The TX DIS signal is transmitted from the signal processor 11b of the communication apparatus 10 to the operation controller 21b of the optical transceiver 20a, and reaches a TX DIS pin of the optical transceiver 20a.

For example, when the TX DIS signal reaches the TX DIS pin at the H level, the operation controller 21b drives an E/O 23a and causes the E/O 23a to generate signal light and output the generated signal light to the outside (via an optical fiber) using the TX DIS signal. On the other hand, when the TX DIS signal reaches the TX DIS pin at the L level, the operation controller 21b stops the driving of the E/O 23a and causes the E/O 23a to stop the output of the signal light.

A Mod ABS signal indicates whether the optical transceiver 20a is inserted into the communication apparatus 10. When the optical transceiver 20a is inserted into the communication apparatus 10, the output signal of the Mod ABS pin of the optical transceiver 20a becomes the L level (the operation controller 21b outputs the Mod ABS signal having the L level).

When the optical transceiver 20a is detached from the communication apparatus 10, the output signal of the Mod ABS pin of the optical transceiver 20a becomes the H level (the operation controller 21b outputs the Mod ABS signal having the H level). The communication apparatus 10 can recognize an insertion state of the optical transceiver 20a from a level of the output signal of the Mod ABS pin.

On the other hand, the CDR unit 22 receives a data signal and extracts a clock signal, thus realizing a retiming of the data signal. The E/O unit 23a converts the data signal to signal light and outputs the converted signal light to the outside. The O/E unit 23b receives signal light transmitted from the outside and converts the received signal light to an electric signal. The operation controller 21b controls the driving of the E/O unit 23a and the O/E unit 23b.

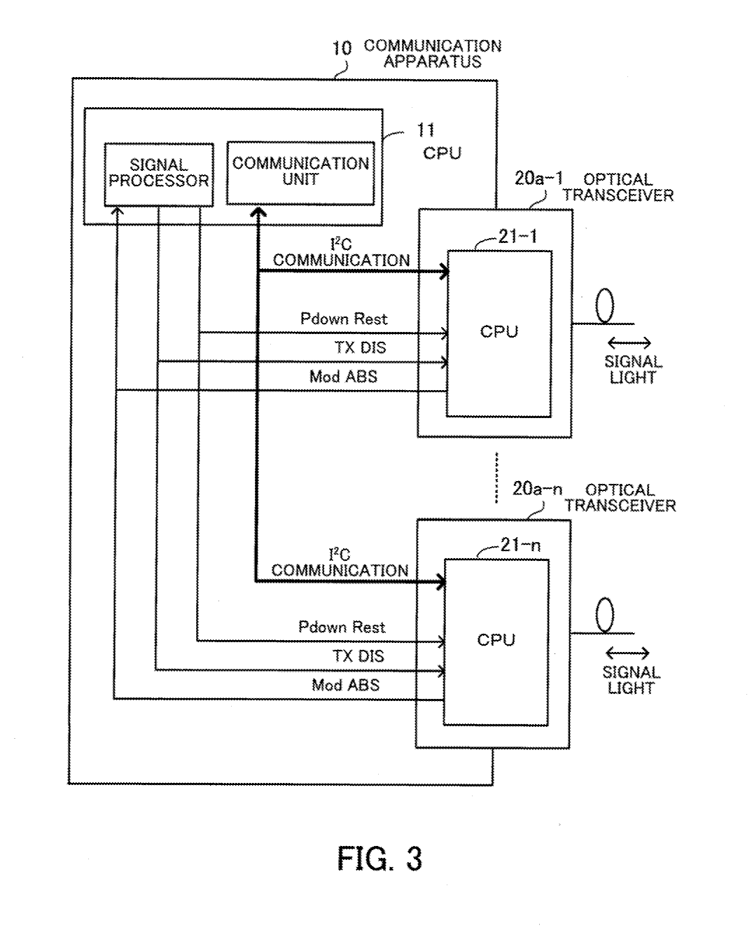

FIG. 3 illustrates a configuration at the time when a plurality of optical transceivers are inserted into the communication apparatus 10. The optical transceivers 20a-1 to 20a-n in the number of n are inserted into the communication apparatus 10. The CPU 11 of the communication apparatus 10 includes the communication unit 11a and signal processor 11b illustrated in FIG. 1. Further, the optical transceivers 20a-1 to 20a-n includes CPUs 21-1 to 21-n, respectively.

The I²C communication is performed between the communication unit 11a of the CPU 11 and the communication units 21a of the CPUs 21-1 to 21-n. Further, the control signals (the Pdown Rest signals, the TX DIS signals, and the Mod ABS signals) are exchanged between the signal processor 11b of the CPU 11 and the operation controllers 21b of the CPUs 21-1 to 21-n.

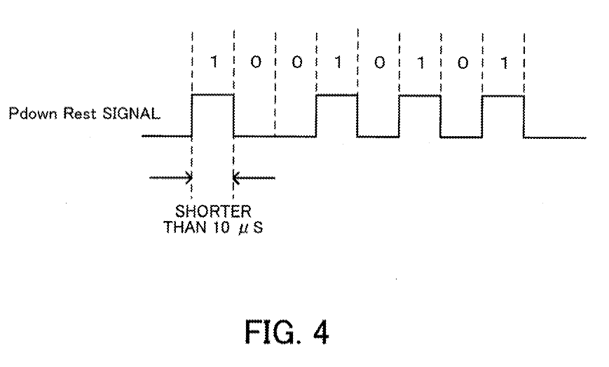

Operations at the time of authenticating the optical transceiver 20a will be described below. FIG. 4 illustrates an authentication pattern at the time of authenticating the optical transceiver 20a. When authenticating whether the optical transceiver 20a inserted into the communication apparatus 10 is a normal optical transceiver, the signal processor 11b changes a level of the Pdown Rest signal into the authentication pattern and transmits the changed Pdown Rest signal to the optical transceiver 20a.

Referring now to FIG. 4, suppose, for example, that a pattern “10010101” is the authentication pattern. The signal processor 11b changes a level of the Pdown Rest signal into this authentication pattern and transmits the changed Pdown Rest signal to the optical transceiver 20a.

The operation controller 21b of the optical transceiver 20a compares a level change pattern of the received Pdown Rest signal and the previously recognized authentication pattern (“10010101”). If a level change pattern of the Pdown Rest signal is a pattern “10010101” and matched with the previously recognized authentication pattern, the operation controller 21b starts an activation operation of the optical transceiver 20a (the operation controller 21b may inform the communication apparatus 10 that the level change pattern of the Pdown Rest signal is matched with the previously recognized authentication pattern). If the level change pattern of the Pdown Rest signal fails to be matched with the previously recognized authentication pattern, the operation controller 21b does not start an activation operation of the optical transceiver 20a (the operation controller 21b may inform the communication apparatus 10 that the level change pattern of the Pdown Rest signal fails to be matched with the previously recognized authentication pattern).

When providing the authentication pattern for the Pdown Rest signal, the signal processor 11b generates the authentication pattern of the H level having a period shorter than or equal to 10 μs. The reason is that when a period of the H level is longer than 10 μs, the Pdown Rest signal performs an original operation (setting of the standby state).

Accordingly, when setting the optical transceiver 20a to the standby state, the signal processor 11b sets the Pdown Rest signal to have the H level with a period of 10 μs or longer, whereas when releasing the optical transceiver 20a from the standby state, the signal processor 11b sets the Pdown Rest signal to have the L level for a given length of time.

When authenticating the optical transceiver 20a, the signal processor 11b changes a level of the Pdown Rest signal into the authentication pattern and transmits the changed Pdown Rest signal to the optical transceiver 20a (sets the Pdown Rest signal to have the H level with a period shorter than or equal to 10 μs). As can be seen from the above discussion, the proposed communication system 1 uses one Pdown Rest signal for both the setting and release of the standby state of the optical transceiver 20a and the authentication of the optical transceiver 20a.

This process permits the optical transceiver 20a to be authenticated using the Pdown Rest signal being one control signal not dependent on the I²C communication and therefore, illegal use of the unauthorized optical transceiver can be definitely prevented. Since using the existing Pdown Rest signal eliminates the need to add circuits, the communication system 1 can efficiently perform the authentication control.

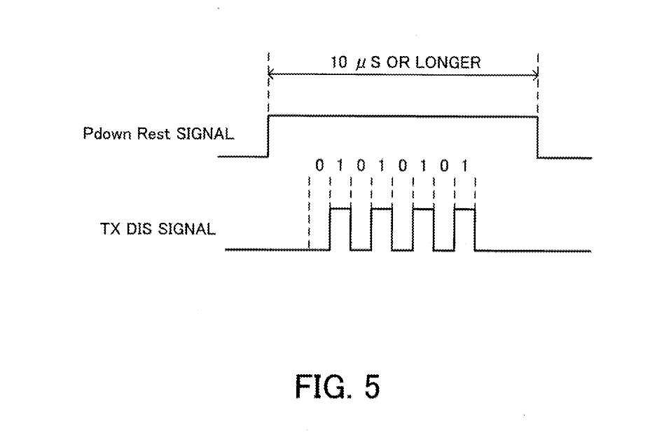

Operations at the time of authenticating the optical transceiver 20a using two control signals of the Pdown Rest signal and the TX DIS signal will be described below. FIG. 5 illustrates the authentication pattern at the time of authenticating the optical transceiver 20a. The signal processor 11b performs the authentication in combination of the Pdown Rest signal and the TX DIS signal when authenticating whether the optical transceiver 20a inserted into the communication apparatus 10 is an unauthorized optical transceiver.

The signal processor 11b outputs the Pdown Rest signal having the H level with a period of 10 μm or longer and sets the optical transceiver 20a to the standby state. Further, the signal processor 11b provides the TX DIS signal with a level of the authentication pattern and transmits the TX DIS signal at the time of a time band of the H level of the Pdown Rest signal.

Here, when the signal processor 11b transmits only the TX DIS signal with the authentication pattern, the optical transceiver 20a outputs or stops signal light in accordance with a level change of the TX DIS signal (activates an original optical communication operation).

As compared with the above-described process, after setting the optical transceiver 20a to the standby state using the Pdown Rest signal, the signal processor 11b transmits the TX DIS signal with the authentication pattern. This process permits the optical transceiver 20a to be authenticated in the state where the optical transceiver 20a stops the signal light (in FIG. 5, the authentication pattern is set to a pattern “01010101”).

As can be seen from the above discussion, the communication system 1 uses one TX DIS signal for both the output and stop of the signal light from the optical transceiver 20a and the authentication of the optical transceiver 20a (note that when authenticating the optical transceiver 20a, the signal transceiver 11b sets the optical transceiver 20a to the standby state using the Pdown Rest signal and then provides the TX DIS signal with the authentication pattern).

This process permits the optical transceiver 20a to be authenticated using the TX DIS signal being one control signal not dependent on the I²C communication. As a result, illegal use of the unauthorized optical transceiver can be definitely prevented. Further, since using the existing TX DIS signal eliminates the need to add circuits, the communication system 1 can efficiently perform the authentication control.

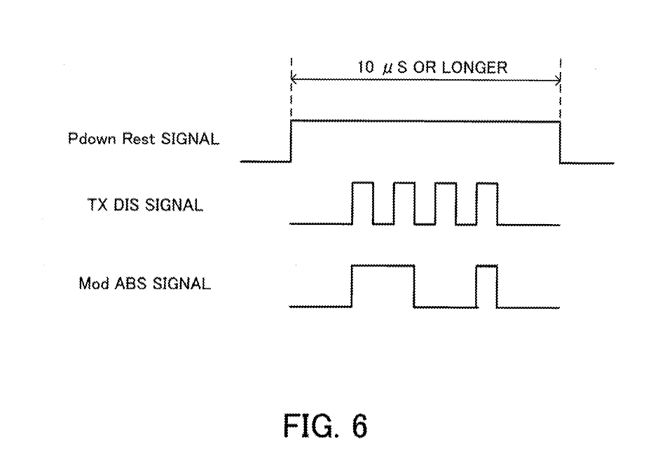

Operations at the time of performing a monitor control of the optical transceiver 20a using three control signals of the Pdown Rest signal, the TX DIS signal, and the Mod ABS signal will be described below. FIG. 6 illustrates a monitor pattern at the time of performing the monitor control of the optical transceiver 20a. When monitoring a function of the optical transceiver 20a inserted into the communication apparatus 10, the signal processor 11b specifies a function to be monitored for the optical transceiver 20a in combination of the Pdown Rest signal and the TX DIS signal.

The signal processor 11b outputs the Pdown Rest signal having the H level with a period of 10 μs or longer and sets the optical transceiver 20a to the standby state. Further, the signal processor 11b provides the TX DIS signal with a level of the monitor pattern (a pattern different from the authentication pattern) and transmits the TX DIS signal at the time of a time band of the H level of the Pdown Rest signal.

Here, when the signal processor 11b transmits only the TX DIS signal with the monitor pattern, the optical transceiver 20a outputs or stops the signal light in accordance with a level change of the TX DIS signal (activates an original optical communication operation).

As compared with the above-described process, the signal processor 11b sets the optical transceiver 20a to the standby state using the Pdown Rest signal and then transmits the TX DIS signal with the monitor pattern. This process permits the signal processor 11b to specify a function to be monitored within the optical transceiver 20a in accordance with the monitor pattern in the state where the optical transceiver 20a stops the signal light.

On the other hand, the optical transceiver 20a is set to the standby state by the Pdown Rest signal. When receiving the TX DIS signal with the monitor pattern at the time of the standby state, the optical transceiver 20a monitors a function to be specified by the monitor pattern. Further, the optical transceiver 20a informs the communication apparatus 10 of monitor results using, for example, the Mod ABS signal in a time band of the standby state.

Here, examples of the monitor content of the functions of the optical transceiver 20a include TX bias data, laser wavelength data, LD (laser diode) driver bias data, and LD driver amplification data.

The TX bias data is data on a control bias applied to the E/O unit 23a. The laser wavelength data is data on an output wavelength of the LD. The LD driver bias data is bias data on a driving signal of the LD driver. The LD driver amplification data is amplification data on a driving signal of the LD driver in the E/O unit 23a.

MSA has a provision regarding a monitor of the TX bias data, and specifically, the MSA restricts the number of bits (the number of bits of the read current) at the time of informing the communication apparatus 10 of monitor results. However, when using the above-described Mod ABS signal, the optical transceiver 20a can eliminate the need for the restriction of the number of bits and inform the communication apparatus 10 of more detailed information (the MSA has the restriction that the optical transceiver 20a informs the communication apparatus 10 of information using a signal of two bytes, and on the other hand, when using the Mod ABS signal, the optical transceiver 20a can inform the communication apparatus 10 of the information using a signal of two bytes or more).

Also, the MSA has provisions regarding a monitor of the laser wavelength data, and specifically, the MSA has the restriction that the accuracy at the time of informing the communication apparatus 10 of monitor results is 10 pm units. However, when using the above-described Mod ABS signal, the optical transceiver 20a can inform the communication apparatus 10 of more detail information (for example, 1 pm unit).

The MSA has no provisions regarding a monitor of the LD driver bias data and the LD driver amplification data. When knowing transmission characteristics, it is effective to know these monitor information units. As can be seen from the above discussion, the optical transceiver 20a can monitor also a function monitor a provision of which is absent in the MSA.

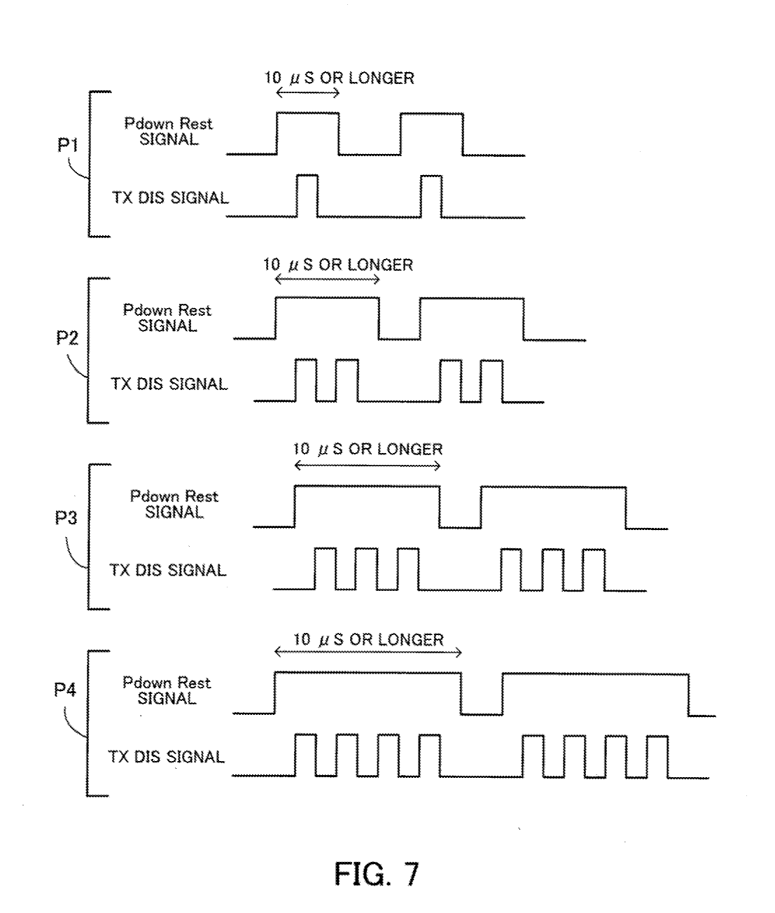

FIG. 7 illustrates one example of a monitor pattern. A pattern P1 is a monitor pattern example at the time of monitoring the TX bias data. A pattern P2 is a monitor pattern example at the time of monitoring the laser wavelength data.

A pattern P3 is a monitor pattern example at the time of monitoring the LD driver bias data. A pattern P4 is a monitor pattern example at the time of monitoring the LD driver amplification data. As described above, since freely associating a function to be monitored and a monitor pattern with each other, the optical transceiver 20a can flexibly expand a monitoring function.

As described above, the proposed communication system 1 permits the communication apparatus 10 to change a level of the control signal to a predetermined level and transmit the control signal when causing the communication module 20 to perform a predetermined operation, change a level of the control signal to the authentication pattern and transmit the control signal when authenticating the communication module 20, and change a level of the control signal to the monitor pattern and transmit the control signal when monitoring the communication module 20.

Further, the communication module 20 is configured to perform a predetermined operation when a level of the received control signal is a predetermined level, perform authentication control by matching or comparing the authentication pattern with a previously recognized pattern when a level of the received control signal is the authentication pattern, and perform monitor control in order to perform a function monitor corresponding to each pattern of the monitor patterns and inform the communication apparatus 10 of the monitor result when a level of the received control signal is the monitor pattern.

This communication system 1 makes it possible to use existing control signals and perform a two-way communication that is not restricted in the provisions of the general-purpose communication protocol between the communication apparatus 10 and the communication module 20 by a communication format different from the general-purpose communication protocol. Therefore, the communication system 1 permits authentication accuracy of the communication module 20 to be improved. Further, the communication system 1 permits the communication module 20 to perform monitoring with accuracy and improve monitoring accuracy.

The proposed communication system 1 permits the communication quality and the reliability to be improved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions has (have) been described in detail, it should be understood that various changes, substitutions and alterations could be made hereto without departing from the spirit and scope of the invention.

What is claimed is:

1. A communication system to perform information communication, the communication system comprising:
a communication module including an operation controller that controls an operation of itself based on a control signal having no general-purpose communication protocol; and
a communication apparatus including a signal processor that generates the control signal and transmits the generated control signal to the communication module inserted into itself, wherein:
the signal processor:
transmits, when causing the communication module to perform a predetermined operation, the control signal at a predetermined level, and
changes, when authenticating the communication module, a level of the control signal into an authentication pattern and transmits the control signal; and
the operation controller:
performs, when a level of the received control signal is the predetermined level, the predetermined operation, and
performs, when a level of the received control signal is the authentication pattern, authentication control by matching or comparing the authentication pattern with a previously recognized pattern.

2. The communication system according to claim 1, wherein:
the signal processor:
transmits the control signal at the predetermined level, and causes the communication module to perform setting and release of a standby state as the predetermined operation;
transmits the same control signal at a level of the authentication pattern, and authenticates the communication module; and
uses the one control signal for setting and release of the standby state of the communication module and for authentication of the communication module.

3. A communication system to perform information communication, the communication system comprising:
a communication module including an operation controller that controls an operation of itself based on a control signal having no general-purpose communication protocol; and
a communication apparatus including a signal processor that generates the control signal and transmits the generated control signal to the communication module inserted into itself, wherein:
the signal processor:
transmits, when causing the communication module to perform a predetermined operation, the control signal at a predetermined level;
changes, when authenticating the communication module, a level of the control signal into an authentication pattern and transmits the control signal; and
changes, when monitoring the communication module, a level of the control signal into a monitor pattern and transmits the control signal; and
the operation controller:
performs, when a level of the received control signal is the predetermined level, the predetermined operation;
performs, when a level of the received control signal is the authentication pattern, an authentication control by matching or comparing the authentication pattern with a previously recognized pattern; and
performs, when a level of the received control signal is the monitor pattern, monitor control in order to perform a function monitor corresponding to each pattern of the monitor pattern and inform the communication apparatus of monitor results.

4. The communication system according to claim 3, wherein:
the signal processor:
transmits the control signal at the predetermined level, and causes the communication module to perform setting and release of a standby state as the predetermined operation;
transmits the same control signal at a level of the authentication pattern and authenticates the communication module; and
uses the one control signal for setting and release of the standby state of the communication module and for authentication of the communication module.

5. The communication system according to claim 3, wherein:
the signal processor:
generates a first control signal that causes the communication module to perform setting and release of a standby state as the predetermined operation;
generates a second control signal that causes the communication module to perform output and stop of communication data as the predetermined operation;
transmits, when authenticating the communication module, the first control signal at the predetermined level, sets the communication module to the standby state, transmits the second control signal at a level of the authentication pattern to the communication module set to the standby state, and authenticates the communication module; and
transmits, when monitoring the communication module, the first control signal at the predetermined level, sets the communication module to the standby state, transmits the second control signal at a level of the monitor pattern to the communication module set to the standby state, and monitors the communication module.

6. A communication apparatus to communicate with a communication module that is inserted into itself, the communication apparatus comprising:
a communication unit to communicate with the communication module using a general-purpose communication protocol; and
a signal processor to generate a control signal having no general-purpose communication protocol and transmit the generated control signal to the communication module, wherein:
the signal processor:
transmits, when causing the communication module to perform a predetermined operation, the control signal at a predetermined level;
changes, when authenticating the communication module, a level of the control signal into an authentication pattern and transmits the control signal; and
changes, when monitoring the communication module, a level of the control signal into a monitor pattern and transmits the control signal.

7. The communication apparatus according to claim 6, wherein:
the signal processor:
transmits the control signal at the predetermined level and causes the communication module to perform setting and release of a standby state as the predetermined operation;
transmits the same control signal at a level of the authentication pattern and authenticates the communication module; and
uses the one control signal for setting and release of the standby state of the communication module and for authentication of the communication module.

8. The communication apparatus according to claim 6, wherein:
the signal processor:
generates a first control signal that causes the communication module to perform setting and release of a standby state as the predetermined operation;
generates a second control signal that causes the communication module to perform output and stop of communication data as the predetermined operation;
transmits, when authenticating the communication module, the first control signal at the predetermined level, sets the communication module to the standby state, transmits the second control signal at a level of the authentication pattern to the communication module set to the standby state, and authenticates the communication module; and
transmits, when monitoring the communication module, the first control signal at the predetermined level, sets the communication module to the standby state, transmits the second control signal at a level of the monitor pattern to the communication module set to the standby state, and monitors the communication module.

9. A communication module to be inserted into a communication apparatus and communicate with the communication apparatus, the communication module comprising:
a communication unit to communicate with the communication apparatus using a general-purpose communication protocol; and
an operation controller to control an operation of itself based on a control signal having no general-purpose communication protocol, which is transmitted from the communication apparatus, wherein:
the operation controller:
performs, when a level of the received control signal is a predetermined level, a predetermined operation;
performs, when a level of the received control signal is an authentication pattern, authentication control by matching or comparing the authentication pattern with a previously recognized pattern; and
performs, when a level of the received control signal is a monitor pattern, monitor control in order to perform a function monitor corresponding to each pattern of the monitor pattern and inform the communication apparatus of monitor results.

10. The communication module according to claim 9, wherein:
the operation controller:
receives the control signal with the predetermined level and performs setting and release of a standby state as the predetermined operation; and
receives the same control signal with a level of the authentication pattern and performs the authentication control, thereby performing setting and release of the standby state and the authentication control using the one control signal.

11. The communication module according to claim 9, wherein:
the operation controller:
receives a first control signal that causes the communication module to perform setting and release of a standby state as the predetermined operation,
receives a second control signal that causes the communication module to perform output and stop of communication data with respect to the communication apparatus as the predetermined operation;
in the case of performing the authentication control, when the communication module is set to the standby state by the first control signal transmitted at the predetermined level and receives the second control signal having a level of the authentication pattern at the standby state, performs the authentication control; and
in the case of performing the monitor control, when the communication module is set to the standby state by the first control signal transmitted at the predetermined level and receives the second control signal having a level of the monitor pattern at the standby state, performs the monitor control.
